(19) United States
(12) Patent Application Publication
(10) Pub. No.: US 2020/0232160 A1
(43) Pub. Date: Jul. 23, 2020

(54) SHEATHING ELEMENT AND METHOD FOR SPLICING A ROPE

(71) Applicant: Fatzer AG, Romanshorn (CH)

(72) Inventor: Bruno LONGATTI, Stein (CH)

(21) Appl. No.: 16/632,002

(22) PCT Filed: Jul. 20, 2018
(86) PCT No.: PCT/EP2018/069824

§ 371 Date: Jan. 17, 2020

(30) Foreign Application Priority Data
Jul. 21, 2017 (DE) 10 2017 116 532.0

(51) Int. Cl. D07B 1/16; B61B 12/00

(52) U.S. Cl. CPC D07B 1/162; B66B 7/06; B61B 12/00

(57) ABSTRACT

A sheathing element, in particular a splicing tape, has at least one sheathing portion which is configured for an at least section-wise sheathing of at least one insertion end of at least one splice, embodied as a long splice, for a rope, in particular for a wire rope, advantageously for a haul rope and/or a traction rope, having a diameter d and a number of N stranded longitudinal elements, in particular strands, wherein

the sheathing portion is suitable for permitting the splice to be produced with a length of less than 100*N*d.

### PRIOR ART

The invention relates to a sheathing element as claimed in the preamble of claim 1.

Wire rope splices by means of which continuous wire ropes can be produced from wire ropes, for example as traction ropes or haul ropes for mountain cable cars, are known from the prior art. A so-called long splice herein is made at the application site of the endless rope. In order for such a long splice to be produced, ends of single strands of a wire rope to be spliced are inserted as insertion ends section-wise in the interior of said wire rope, in place of a core of the wire rope. A length of insertion ends of this type herein corresponds to at least 100 times a diameter of the rope such that a splice of a sufficient length and load bearing capability can be generated. A diameter of the insertion ends is typically smaller than a diameter of a core of the wire rope, the insertion ends being inserted into an interior of the wire rope in place of said core, which is why the insertion ends are sheathed with a splicing tape.

The object of the invention lies in particular in achieving advantageous properties with a view to producing a splice, in particular a long splice. An object of the invention moreover lies in particular in providing a sheathing element by means of which a high load bearing capability of sheathed insertion ends can be achieved. An object of the invention moreover lies in particular in enabling a splice, in particular a long splice, to be made at locations which are difficult to access or at spatially tight locations. The invention is achieved according to the invention by the features of patent claim 1, while advantageous design embodiments and refinements of the invention can be derived from the dependent claims.

### Advantages of the Invention

The invention proceeds from a sheathing element, in particular a splicing tape, having at least one sheathing portion which is configured for an at least section-wise sheathing of at least one insertion end of at least one splice, embodied as a long splice, for a rope, in particular for a wire rope, advantageously for a haul rope and/or a traction rope, having a diameter d and a number of N stranded longitudinal elements, in particular strands.

It is proposed that the sheathing portion is suitable for permitting the splice to be produced, in particular of the long splice, with a length of less than 100*N*d, advantageously of at most 80*N*d, particularly advantageously of at most 60*N*d, preferably of at most 50*N*d, and particularly preferably of at most 40*N*d. The sheathing portion is in particular suitable for producing a splice, in particular a long splice, the regions thereof having insertion ends having an overall length of less than 100*N*d, advantageously of at most 80*N*d, particularly advantageously of at most 60*N*d, preferably of at most 50*N*d, and particularly preferably of at most 40*N*d.

Advantageous properties with a view to producing a splice, in particular a long splice, can be achieved on account of the design embodiment according to the invention. Furthermore, a sheathing element can be provided by means of which a high load bearing capability, in particular a high extraction force, of wrapped insertion ends can be achieved. A complexity in the production of insertion ends of a splice, in particular of a long splice, can moreover advantageously be reduced. A splice, in particular a long splice, having short insertion ends that are simple to generate can moreover advantageously be provided. A high efficiency in terms of costs, in particular of a sheathing of insertion ends when producing splices, can advantageously be achieved, advantageously at the same time in combination with a high reliability of a finished splice, in particular a long splice. In particular, a short time required for splicing can be achieved. Moreover, a compact splice capable of bearing loads, in particular a long splice, can be provided. Furthermore, splicing, in particular a long splice, can advantageously be enabled in a tight space and/or on a short length. In particular, a length of a region of a spliced connection to be processed in a complex manner can advantageously be reduced, in particular by means of a long splice.

The invention moreover comprises a rope portion of a rope, in particular of an endless rope, preferably of a wire rope, in particular a person transporting wire rope, having at least one splice embodied as a long splice, in particular a wire rope splice, which has a plurality of stranded longitudinal elements, in particular strands, at least one of which has at least one insertion end which is inserted between other longitudinal elements at least section-wise, in particular in place of a core, and which at least is sheathed at least section-wise with at least one sheathing portion of at least one sheathing element as claimed in one of the preceding claims.

In particular, the rope and/or the rope portion have/has a nominal diameter of d. The diameter d is preferably the nominal diameter of the rope. In particular, the diameter d is a diameter of a smallest circle surrounding the rope and/or the rope portion, in particular the cross section thereof. The rope is preferably a wire rope, in particular a steel wire rope. The rope particularly preferably has at least one, in particular precisely one, core. The rope is advantageously at least in part implemented from a plastics material. The longitudinal elements preferably run in the manner of a spiral about the core, in particular in the manner of a conventional wire rope, and are in particular stranded around said core. In particular, a lay length of the longitudinal elements is at least 4*d, preferably at least 6*d, and/or at most 12*d, and preferably at most 9*d. The longitudinal elements are advantageously disposed about the core in such a manner that said longitudinal elements are disposed so as to be without mutual contact and/or so as to be mutually spaced apart in terms of the longitudinal directions of said longitudinal elements, at least in portions of the rope and/or of the rope portion that are different from spliced locations, on account of which wear by virtue of mutually rubbing longitudinal elements can in particular be avoided or at least reduced. The rope is advantageously configured for use in a ropeway, in particular in a person transporting rope system. However, the rope can also be configured for use in a ropeway for transporting materials. The rope is in particular an endless rope, preferably of a ropeway. The ropeway can be, for example, a passenger cableway, in particular a mountain cable car, and advantageously an urban cable car. Alternatively or additionally, the ropeway can at least in part or in full be disposed underground. A ropeway for transporting materials, in particular a material transport ropeway, is likewise conceivable. The rope is advantageously a haul rope, in particular a revolving and/or continuous haul rope, and/or a traction rope, in particular a revolving and/or continuous traction rope. The rope in an assembled state is advantageously placed around at least one drive element, in particular around a drive pulley, of a drive unit of a ropeway. “Configured” is in particular to mean specifically designed and/or equipped. An object being configured for a certain function is in particular to mean that said object in at least one application state and/or operating state fulfils and/or carries out said certain function.

The rope advantageously has a consistent diameter. The diameter of the rope herein can be chosen so as to be suitable for a specific application. The diameter is in particular at least 10 mm and/or at most 100 mm. For example, if the rope is a traction rope, the diameter is in particular at least 10 mm and advantageously at least 20 mm and/or at most 70 mm and advantageously at most 50 mm. For example, if the rope is a haul rope, the diameter is in particular at least 30 mm and advantageously at least 40 mm and/or at most 100 mm and advantageously at most 90 mm. Moreover, the rope preferably has a consistent cross section, or a cross section that is periodically present at least along the longitudinal direction of said rope. The cross section can be circular, in particular in the case of the rope, between longitudinal elements running on the surface of said rope, having suitable inserts which advantageously fill intermediate spaces between the longitudinal elements. It is likewise conceivable that the cross section corresponds to that of a conventional wire rope having strands disposed about a core.

The rope is in particular free of at least one sheathing that at least partially surrounds the rope, in particular a plastics material sheathing, a metal sheathing, a nylon sheathing, and/or a further sheathing that in particular influences a tensile strength of the rope. Each stranded longitudinal element, in particular with the exception of insertion ends, is in particular free of at least one sheathing that surrounds the stranded longitudinal element, in particular a plastics material sheathing, a metal sheathing, a nylon sheathing, and/or a further sheathing that in particular influences a tensile strength of the rope. An element “being at least largely free of sheathings” is to be understood in particular that at least 51%, preferably at least 75%, advantageously at least 85%, preferably at least 95%, and particularly preferably at least 99%, of the element is free of sheathings that surround the element. A “sheathing” is in particular to be understood to be an element which at least section-wise, in the circumferential direction, at least partially surrounds the person transporting wire rope and/or the longitudinal element, and which is preferably implemented from a material that is different from the material, in particular from the wire material, of the person transporting wire rope and/or of the longitudinal element. The wording “partially surrounding” is to be understood in particular so as to surround an overall circumference at least to the extent of 51%, preferably at least to the extent of 80%, or preferably at least to the extent of 95%.

The rope has in particular N longitudinal elements, in particular in addition to the core. Preferably, N=6. The rope is in particular a six-strand wire rope. However, seven-strand or eight-strand ropes are likewise conceivable. N is in particular at least 4, advantageously at least 5, and particularly advantageously at least 6 and/or at most 12, advantageously at most 10, and particularly advantageously at most 8. The longitudinal elements advantageously have in each case an at least substantially consistent cross section. The longitudinal elements are preferably strands which in turn can be constructed from a plurality of individual wires which can in particular be implemented so as to be at least substantially mutually identical. It is likewise conceivable that a longitudinal element, for example embodied as a strand, comprises dissimilar individual wires and/or other components such as inserts, fibers, sheathing elements, or the like. In particular in the case of a longitudinal element being embodied as a strand, the longitudinal element advantageously has a lay length which corresponds to at least five times, and preferably at least seven times, and/or at most 15 times, and preferably at most eleven times, a diameter of the longitudinal element. In principle, longitudinal elements of dissimilar lays can be used. Moreover, a lay direction of the wire rope can be identical to or counter to a lay direction of the longitudinal elements, or of at least individual longitudinal elements. “At least substantially identical” objects is in particular to be understood to be objects which are constructed in such a manner that said objects can in each case fulfil a common function and, apart from production tolerances, in terms of construction differ from one another at most on account of individual elements which are irrelevant to the common function, and advantageously objects which, apart from production tolerances and/or in the context of production-related possibilities, are of identical configuration, wherein mutually symmetrical objects are in particular also to be understood to be identical objects. An object having “an at least substantially consistent cross section” herein is to be understood in particular that, for an arbitrary first cross section of the object along at least one direction and an arbitrary second cross section of the object along the direction, a minimum area of a differential area which is formed when superimposing the cross section is at most 20%, advantageously at most 10%, and particularly advantageously at most 5%, of the area of the larger of the two cross sections.

A “wire” in this context is to be understood in particular to be an elongate and/or thin member and/or which is capable of being at least mechanically bent and/or is flexural. The wire along the longitudinal direction thereof advantageously has an at least substantially consistent, in particular circular or elliptic, cross section. The wire is particularly advantageously embodied as a round wire. However, it is also conceivable for the wire at least section-wise or in full to be embodied as a flat wire, a rectangular wire, a polygonal wire, and/or a profiled wire. For example, the wire at least in part or else in full can be implemented from metal, in particular a metal alloy, and/or an organic and/or an inorganic plastics material, and/or a composite material, and/or an inorganic non-metallic material, and/or a ceramic material. For example, it is conceivable for the wire to be embodied as a polymer wire or a plastics material wire. The wire can in particular be embodied as a composite wire, for example as a metal/organic composite wire, and/or a metal/inorganic composite wire, and/or a metal/polymer composite wire, and/or a metal/metal composite wire, or the like. It is in particular conceivable that the wire comprises at least two dissimilar materials which are disposed relative to one another in particular according to a composite geometry and/or are at least in part mixed with one another. The wire is advantageously embodied as a metal wire, preferably as a steel wire, in particular as a stainless steel wire. Should the helix have a plurality of wires, the latter are preferably identical. However, it is also conceivable for the helix to have a plurality of wires which differ from one another in particular in terms of the material thereof, and/or the diameter thereof, and/or the cross section thereof. The wire and/or the longitudinal element preferably have an in particular corrosion-resistant coating and/or sheathing such as, for example, a zinc coating and/or a zinc/aluminum coating and/or a plastics material coating and/or a PET coating and/or a metal oxide coating and/or a ceramic coating, or the like.

The splice is advantageously a long splice, and/or produced in the manner of a long splice. The splice is preferably a wire rope splice. The number of longitudinal elements of the splice preferably corresponds to the number of longitudinal elements of the rope. The longitudinal elements of the splice are particularly preferably the longitudinal elements of the rope. The splice is preferably made from a master rope of the rope, prior to said rope being connected so as to form an endless rope. The splice is in particular a connection location between ends of the master rope of the rope. The rope advantageously has at least one further rope portion which is free of any splice. The rope portion and the further rope portion preferably configure the rope. However, it is likewise conceivable that the rope has a plurality of rope portions which comprise in each case at least one splice, for example should part of the rope be replaced and a corresponding replacement part being spliced thereinto by means of at least two splices. The splice advantageously has a maximum diameter, in particular a nominal diameter, which deviates from the diameter d of the rope by at most 10%, advantageously by at most 8%, particularly advantageously by at most 6%, and preferably by at most 5%, and in particular is larger than said diameter d.

At least some and advantageously all of the longitudinal elements preferably configure in each case at least one insertion end. At least some and advantageously all of the longitudinal elements particularly preferably configure in each case precisely two insertion ends, wherein one insertion end is in each case advantageously realized by respectively one end of a longitudinal element. The insertion ends are advantageously inserted into an interior of the rope portion, in place of the core. The splice particularly advantageously has a plurality of splice locations, in particular N splice locations, where longitudinal elements and preferably insertion ends preferably intersect in particular in such a manner that said longitudinal elements and said insertion ends penetrate an interior of the splice in opposite directions. The splice location comprises in particular at least one, in particular precisely one, splice knot, preferably a reef knot. The splice in the region of the splice location advantageously has N+1 longitudinal elements lying on a surface, of which preferably two longitudinal elements intersect at the splice location. Alternatively, it is conceivable for two of the longitudinal elements to be placed directly beside one another at the splice location such that said two longitudinal elements form a parallel knot, for example. Said two longitudinal elements, in particular the longitudinal elements that mutually intersect at the splice location, particularly advantageously configure in each case one insertion end, wherein the corresponding insertion ends, in particular proceeding from the splice location, are inserted into the interior of the splice in opposite directions, in place of the core. An insertion end preferably extends in each case from a center of a splice location to an end of the insertion end that lies in particular in the interior of the splice. Two insertion ends that configure one splice location, in each case proceeding from the splice location, particularly preferably extend in opposite directions of the splice, in particular at least predominantly in the interior of said splice, preferably in place of a core.

A length of a portion which lies on a surface of the splice location and which comprises in particular non-inserted portions of the mutually intersecting longitudinal elements, or alternative of the longitudinal elements placed beside one another, and is preferably defined and/or implemented by said portions, is in particular at most 15*d, advantageously at most 10*d, particularly advantageously at most 5*d, and preferably at most 2*d. A length of the splice knot of the splice location is accordingly in particular at most 15*d, advantageously at most 10*d, particularly advantageously at most 5*d, and preferably at most 2*d.

A diameter of the splice in a region of a splice location can be larger than the diameter d of the rope, in particular since a cross section of the splice at the splice location comprises N+1 longitudinal elements. At least one splice location of the splice defines in particular a maximum diameter of the splice.

The splice preferably has 2*N insertion ends, wherein each end of each of the longitudinal elements is particularly preferably an insertion end. However, it is also conceivable that at least two ends of longitudinal elements, or else of each individual longitudinal element, are connected in a butt joint and in particular lie on a surface of the splice, and are for example adhesively bonded and/or welded to one another, and/or are otherwise connected to one another. A number of insertion ends in this case can be less than 2*N. For example, only four longitudinal elements can configure insertion ends for a rope having six longitudinal elements, while two longitudinal elements only lie so as to abut on a surface of a corresponding splice. A breaking force of the splice, for example in this case, is determined mainly by the insertion ends, while the ends of the longitudinal elements that lie in a butt joint and are potentially welded, for instance, can absorb only minor forces. A corresponding splice is advantageously simple to produce, in particular since only a reduced number of longitudinal elements are spliced.

The insertion end advantageously has a length of at most 40*d, particularly advantageously of at most 30*d, preferably of at most 25*d, and particularly preferably of at most 20*d. The splice advantageously has at least 2*N−8, particularly advantageously at least 2*N−6, preferably at least 2*N−4, particularly preferably at least 2*N−2, and preferably 2*N, insertion ends. The splice has in particular at least two, advantageously at least four, particularly advantageously at least six, preferably at least eight, particularly preferably at least ten, and preferably at least twelve and/or 2*N insertion ends which have a length of at most 50*d, advantageously of at most 40*d, particularly advantageously of at most 30*d, preferably of at most 25*d, and particularly preferably of at most 20*d.

The insertion end is advantageously sheathed with the sheathing portion at least across a length of the inserted portion of said insertion end. Particularly advantageously, all of the insertion ends of the splice are in each case at least section-wise sheathed with, preferably wrapped by, at least one sheathing portion and preferably at least across a length of the respective inserted portion of said insertion ends.

The insertion end is in particular wrapped by the sheathing portion. The sheathing portion is in particular configured for being wrapped around an insertion end. The sheathing portion is preferably connected at least section-wise to the insertion end at least in a form-fitting manner. The sheathing portion is in particular placed around the insertion end and/or disposed on the surface thereof in such a manner that the sheathing portion at least in part mimics a surface which is in particular formed by virtue of longitudinal elements that run on a surface of the splice. For example, the sheathing portion could at least in part fill intermediate spaces formed between longitudinal elements running beside one another, and/or intermediate spaces formed between individual wires of a longitudinal element, so as to configure in particular a form-fitting connection to said longitudinal elements and/or said individual wires.

Alternatively or additionally, it is conceivable that the sheathing portion is configured to be shrink-fitted onto the insertion end, and/or at least section-wise is shrink-fitted onto the insertion end. The sheathing portion, preferably in an initial state in which said sheathing portion has in particular not yet been shrunk, may in particular be configured to be pull-fitted over the insertion end. Furthermore, the sheathing portion, after being pull-fitted, can advantageously be configured to be shrink-fitted onto the insertion end. The sheathing portion, by means of at least one temperature treatment, in particular by means of heating, for example by at least 30 K, advantageously by at least 40 K, preferably by at least 50 K, however likewise also by, for example, 100 K or more, is preferably configured for being shrink-fitted. The sheathing portion in particular in this case can at least in part be implemented from a material of which the volume is modified in a temperature treatment, in particular when heated. It is likewise conceivable that the sheathing portion for pull-fitting is configured to be, for example, thermally widened and/or enlarged, in particular by means of heating, wherein the sheathing portion moreover can preferably be configured so as to contract after being pull-fitted, in particular after a thermal treatment for the pull-fitting. “Pull-fitting” the sheathing portion over the insertion end in this context is in particular to mean attaching said sheathing portion to the surface of said insertion end, for example by placing and/or wrapping, and advantageously by forcing and/or pulling said sheathing portion over said insertion end. It is in particular conceivable for the sheathing portion to be implemented in the manner of a hose and/or tubular, and is advantageously configured to be pulled over from one end of the insertion end.

It is moreover conceivable that the sheathing portion is configured for extruding onto the insertion end, and/or is extruded onto the insertion end. The sheathing portion and/or the sheathing element can in particular be embodied as an extruded coating which is in particular capable of being applied directly to a surface of the insertion end, and/or is applied directly to the latter. It is advantageously conceivable herein that the sheathing portion at least section-wise is connected in a form-fitting manner to the insertion end, and in particular at least section-wise penetrates intermediate spaces between longitudinal elements disposed on the surface of the insertion end, and/or at least section-wise mimics a shape of said intermediate spaces. Moreover, co-extruding at least two dissimilar materials is also conceivable herein.

By the sheathing portion being suitable for permitting the splice to be produced with a specific length is in particular to be understood that the splice in the case of at least the insertion end being sheathed with the sheathing element, and preferably in the case of all of the insertion ends of the splice being sheathed with sheathing portions of characteristics identical to those of the sheathing portion, in the intended use of the splice in which, for example, tensile and/or flexural loads of the splice according to a use in a ropeway arise, preferably in the use of said splice as a splice of an endless rope, in particular as a haul rope and/or a traction rope of a ropeway, is free of damage and/or is capable of being used without damage. In particular the insertion end, and advantageously all of the insertion ends, of the splice herein should be shorter than 50*d. This is furthermore to be understood in particular that the corresponding splice has a break strength, in particular a tensile strength, which is at most 30%, advantageously at most 20%, particularly advantageously at most 10%, and preferably at most 5%, smaller than a break strength, in particular a tensile strength, of a portion of the rope that is different from the splice and in particular is free of any splice. The sheathing portion is advantageously suitable for sheathing an insertion end of a length of at most 50*d in such a manner that said insertion end is resistant to extraction. The insertion end herein is advantageously to be considered resistant to extraction in as far as said insertion end, in particular in the case of all of the insertion ends of the splice having a corresponding extraction force, would display a break strength, in particular a tensile strength, of the corresponding splice which is at most 30%, advantageously at most 20%, particularly advantageously at most 10%, and preferably at most 5%, less than a break strength, in particular a tensile strength, of a rope portion of the rope that is different from the splice and in particular is free of any splice.

The sheathing element is preferably embodied as a tape, in particular as a wrapping tape, advantageously as a splicing tape. The sheathing element and in particular the sheathing portion may be realized in a one-part implementation. It is likewise conceivable for the sheathing element and in particular the sheathing portion to have a plurality of, in particular permanently connected, component parts. The sheathing portion is in particular a portion of the sheathing element. For example, the sheathing element can be a tape roll from which the sheathing portion is capable of being severed, for example cut off. The sheathing element advantageously has a length which is sufficient for sheathing more than one insertion end. It is likewise conceivable for a plurality of sheathing portions to be used for sheathing the insertion end, said sheathing portions being in particular placed on top of one another and/or beside one another about the insertion end, in particular being wound around the insertion end. It is moreover conceivable herein that an insertion end section-wise is sheathed with sheathing portions that are of mutually dissimilar configurations and which can differ from one another in terms of the characteristics thereof. For example, one end of the insertion end can be sheathed with a sheathing portion that is different from that used for a central piece of the insertion end, wherein arbitrary variants are conceivable. The sheathing portion, prior to inserting the insertion end, is preferably configured to be placed, advantageously wrapped, around said insertion end, in place of the core. The sheathing portion by means of sheathing is particularly preferably configured for enlarging a diameter and/or a cross section of the insertion end, in particular so as to adapt said diameter to a diameter and/or a cross section of the core.

The sheathing portion is in particular temperature-resistant at least at a temperature of at least −25° C., advantageously of at least −35° C., and particularly advantageously of at least −50° C., and/or at temperatures of up to 70° C., advantageously of up to 80° C., and particularly advantageously of up to 100° C. “Temperature-resistant” at a specific temperature herein is to be understood in particular that the sheathing portion survives dwelling at this temperature for at least one hour, and advantageously for at least one day, as well as preferably subsequent cooling or heating to 0° C. and/or to 20° C. without damage.

The sheathing portion is advantageously at least partially and preferably at least largely implemented from a plastics material. The sheathing portion is preferably implemented in multiple tiers and/or multiple layers, wherein tiers and/or layers of the sheathing portion can advantageously be connected to one another in an in particular force-fitting and/or form-fitting manner, preferably be adhesively bonded and/or interwoven and/or stitched and/or braided. The sheathing portion advantageously has at least one layer, in particular a surface layer, which is at least partially and preferably at least largely implemented from rubber, in particular from synthetic rubber, advantageously from polypropylene rubber.

The sheathing portion particularly advantageously has at least one surface layer disposed on an upper side, and at least one surface layer disposed on an underside, said surface layers being in each case at least partially and advantageously largely implemented from rubber. The term “at least largely” herein is to be understood in particular to mean to the extent of at least 55%, advantageously to at least 65%, preferably to at least 75%, particularly preferably to at least 85%, and particularly advantageously to at least 95%, in particular however also completely.

The sheathing portion has in particular a width of at least 7 mm, advantageously of at least 10 mm, particularly advantageously of at least 15 mm, and preferably of at least 20 mm and/or of at most 60 mm, advantageously of at most 50 mm, particularly advantageously of at most 40 mm, and preferably of at most 30 mm. For example, the sheathing portion can have a width of 20 mm or of 25 mm. However, depending on the application and in particular depending on the diameter d of the rope, and/or on a diameter and/or cross section of the insertion end, other widths, in particular larger or smaller widths, are also conceivable. In the case of a width of at least substantially 20 mm or of at least substantially 25 mm, for example, the sheathing portion can have a thickness of at least 1.5 mm, advantageously of at least 1.8 mm, and particularly advantageously of at least 2 mm, and/or of at most 5 mm, advantageously of at most 4 mm, and particularly advantageously of at most 3.8 mm. In the case of a width of at least substantially 15 mm, for example, the sheathing portion can have a thickness of at least 0.7 mm, advantageously of at least 0.9 mm, and particularly advantageously of at least 1 mm, and/or of at most 3 mm, advantageously of at most 2 mm, and particularly advantageously of at most 1.65 mm. In the case of a width of at least substantially 10 mm, for example, the sheathing portion can have a thickness of at least 0.5 mm, advantageously of at least 0.6 mm, and particularly advantageously of at least 0.7 mm, and/or of at most 2 mm, advantageously of at most 1.5 mm, and particularly advantageously of at most 0.95 mm. “At least substantially” in this context is to be understood that a deviation from a predefined value corresponds in particular to less than 20%, preferably less than 10%, and particularly preferably less than 5%, of the predefined value.

The sheathing portion in a wrapped state of an insertion end has in particular a wrapping angle of at least 10°, preferably of at least 15°, advantageously of at least 20°, particularly advantageously of at least 30°, preferably of at least 35°, and particularly preferably of at most 40°. A “wrapping angle” is to be understood in particular as an angle which encloses a lateral edge of the sheathing portion that wraps the insertion end and a plane that runs so as to be perpendicular to a longitudinal direction of the insertion end. However, depending on the application and in particular depending on the diameter d of the rope, and/or on a diameter and/or a cross section of the insertion end, other wrapping angles, in particular larger or smaller wrapping angles, are also conceivable. In particular, the lateral edges of the sheathing portion contact one another in the wrapped state of the insertion end. In particular, the sheathing portion in the wrapped state of the insertion end is wrapped so as to be free of any overlaps with itself and/or with further sheathing portions about the insertion end, in particular wrapped about the entire region of the insertion end that is inserted into the rope in place of the core. In particular, the sheathing portion in the wrapped state of the insertion end is wrapped without any gaps about the insertion end, in particular wrapped about the entire region of the insertion end that is inserted into the rope in place of the core.

In an advantageous implementation of the invention it is proposed that a test insertion end which is inserted into a test rope piece having N stranded longitudinal elements and which is sheathed with a test piece of the sheathing portion, said test insertion end being of a length of at most 50*d, advantageously of at most 45*d, particularly advantageously of at most 40*d, preferably of at most 35*d, and particularly preferably of at most 30*d, in particular in at least one test attempt, withstands an extraction force in kN of at least d²*0.68/N*0.04, advantageously of at least d²*0.68/N*0.1, particularly advantageously of at least d²0.68/N*0.2, preferably of at least d²0.68/N*0.4, and particularly preferably of at least d²*0.68/N*0.6. A high degree of mechanical reliability and/or load bearing capability of a splice can be advantageously achieved on account thereof. Moreover, a compact splice, in particular having short insertion ends, can advantageously be provided with a high service life. A diameter d of the test rope piece herein advantageously corresponds at least substantially to the diameter d of the rope. The test rope piece in a pretensioned state and under a tensile load of the test insertion end in the test attempt is preferably capable of being bent without damage at least 1000 times, advantageously at least 2000 times, particularly advantageously at least 5000 times, preferably at least 10,000 times, and particularly preferably at least 15,000 times, in particular in each case by at least 90°, advantageously in each case by at least 120°, and preferably in each case by at least 150°, about at least one test disk having a diameter of at most 80*d, advantageously of at most 60*d, and particularly advantageously of at most 40*d. In particular, a portion of the test insertion end that is inserted into the test rope piece has a length of at most 50*d, advantageously of at most 40*d, particularly advantageously of at most 30*d. In particular, the test rope piece in the test attempt can be capable of being bent without damage in an alternating manner about two opposite test disks which are advantageously curved in opposite direction by the stated angle as a total angle, thus for example by in each case 45° about a first of the test disks and by 45° about a second of the test disks. The test insertion end is advantageously realized in a manner analogous to the insertion end sheathed with the sheathing portion, and is in particular sheathed in the same manner with a sheathing portion of identical configuration. Moreover, the test rope piece is advantageously realized in a manner analogous to the rope. It is conceivable for the test rope piece to comprise a plurality of insertion ends. It is furthermore conceivable for the test rope piece to comprise an entire test splice. The test rope piece advantageously comprises only one test insertion end which at one end of the test rope piece is preferably inserted into the interior of the said test rope piece in place of the core of the latter. The test rope piece being “capable of being bent without damage” is to be understood in particular that the test insertion end and/or the test insertion ends of the test rope piece, in particular after having performed the test attempt, preferably in the pretensioned state of the test insertion end and/or of the test rope piece, for example at a pretensioning force per cross-sectional area A of the test rope piece of at least 60 N/mm², preferably of at least 250 N/mm², and advantageously of at least 500 N/mm², remain inert. The wording “remain inert” is to be understood in particular that the test rope piece under the effect of the pretensioning force is at least substantially free of any slippage and/or any subsidence of a test insertion end, in particular relative to a remainder of the test rope piece. The test rope piece being “substantially free of any subsidence and/or any slippage” is to be understood in particular that a degree of any subsidence and/or any slippage of the test insertion end, in particular relative to a remainder of the test rope piece, after having performed the test attempt, is smaller than the diameter of the test rope piece, preferably is smaller than half the diameter of the test rope piece, preferably is smaller than a quarter of the diameter of the test rope piece, and particularly preferably is less than a diameter of the core of the test rope piece.

In the case of a combined bending and tensile load, for example in the operation of a ropeway, a reliable and durable splice can in particular be provided when the test rope piece in the test attempt is pretensioned with a pretensioning force per cross-sectional area A of the test rope piece of at least 60 N/mm², advantageously of at least 100 N/mm², advantageously of at least 200 N/mm², preferably of at least 300 N/mm², and particularly preferably of at least 500 N/mm², in particular in the case of a six-strand rope.

It is furthermore proposed that a test piece of the sheathing portion which sheathes the test insertion end, which is inserted in the test rope piece having N stranded longitudinal elements of the length of at most 50*d, withstands a shear modulus of at least 1 MPa, advantageously of at least 5 MPa, and preferably of at least 30 MPa, in particular in a test attempt which is analogous to the above-described test attempt. A high degree of mechanical reliability and/or load bearing capability of a splice can be advantageously achieved on account thereof. Moreover, a compact splice, in particular a long splice having short insertion ends, can advantageously be provided with a high service life.

In a further implementation of the invention, it is proposed that the sheathing portion has at least one first region and at least one second region which differ in terms of at least one material parameter. On account thereof, a high variability in terms of adapting the sheathing element to specific loads to be anticipated can be achieved. The first region and the second region advantageously differ in terms of dissimilar material parameters, in particular in terms of at least two material parameters. The sheathing portion in the first region preferably has a hardness, in particular a Shore A hardness, that is different from that of the second region. In particular, the sheathing portion in the second region has a Shore A hardness of at least 70, advantageously of at least 75, and particularly advantageously of at least 80, and/or of at most 95, and advantageously of at most 90, for example a Shore A hardness of 85. In particular, the sheathing portion in the first region has a Shore A hardness of at least 60, advantageously of at least 65, and particularly advantageously of at least 70, and/or of at most 85, and advantageously of at most 80, for example a Shore A hardness of 75. The Shore A hardness of the sheathing portion in the second region is preferably higher than in the first region by at least 5, and advantageously by at least 10. It is moreover conceivable that the first region and the second region differ in terms of a material and/or an elasticity and/or a temperature resistance and/or a coefficient of friction, or the like. The first region and/or the second region advantageously extend/extends across an entire width of the sheathing portion. The first region and the second region can be disposed so as to be mutually adjacent, or else so as to be mutually spaced apart. For example, the first region and the second region can be disposed on different sides of the sheathing portion. However, a disposal on a common side is also conceivable. The first region and/or the second region in a projection onto the upper side of the sheathing element preferably have/has an area of at least 2 cm², advantageously of at least 10 cm², particularly advantageously of at least 25 cm², and preferably of at least 50 cm². In particular, the first region and/or the second region have/has a width of at least 0.5 cm, and advantageously of at least 1 cm, and/or a length of at least 5 cm, and advantageously of at least 10 cm.

It is furthermore proposed that the first region and the second region differ in terms of a surface structure of the sheathing portion. On account thereof, high extraction forces of sheathed insertion ends can advantageously be achieved. The sheathing portion in the first region preferably advantageously has a greater roughness than in the second region. The sheathing portion in the second region preferably has a smooth and/or polished surface. The sheathing portion in the first region particularly preferably has at least one surface structure. The surface structure can comprise a regular and/or an irregular structure. The surface structure preferably comprises at least one regular disposal of in particular diamond-shaped structural elements, preferably elevations and/or depressions. Alternatively or additionally, structural elements having round, in particular circular, polygonal, elliptic, radiused and/or freely shaped cross sections are conceivable. In particular, the sheathing portion at least in the first region has at least one surface with a mean roughness of at least 0.001*D, advantageously of at least 0.005*D, and particularly advantageously of at least 0.01*D, wherein D is a thickness of the sheathing portion. In principle, it is also conceivable for the sheathing portion in the second region to have a surface structure, preferably with a lower roughness in comparison to the first region.

It is moreover proposed that the first region comprises an underside of the sheathing portion, and the second region comprises an upper side of the sheathing portion. In particular the upper side of the sheathing portion and the underside of the sheathing portion differ at least in terms of the at least one material parameter. The sheathing portion advantageously has a smooth, advantageously polished, upper side and/or a structured underside. On account thereof, a reliable fit of the sheathing portion on an insertion end and/or a high extraction force of the correspondingly sheathed insertion end can advantageously be achieved.

In an advantageous implementation of the invention it is proposed that the sheathing portion has a tear strength, in particular in the longitudinal direction of the sheathing portion, of at least 15 N/mm², advantageously of at least 20 N/mm², and particularly advantageously of at least 25 N/mm². For example, in the case of a width of 20 mm or 25 mm and/or a thickness between 1.8 mm and 3.6 mm, for instance of 2 mm or of 3 mm, the sheathing portion can have a tear strength of at least 1000 N, advantageously of at least 2000 N, particularly advantageously of at least 3000 N, and preferably of at least 4000 N. However, lower absolute tear strength values are likewise conceivable for smaller widths and/or for smaller thicknesses. On account thereof, a high reliability and/or load bearing capability of inserted insertion ends can be achieved, in particular in the event of a tensile load and/or a flexural load on a corresponding splice.

In a particularly advantageous implementation of the invention it is proposed that the sheathing portion has at least one, in particular planar, reinforcement. Durability can advantageously be achieved on account thereof. Moreover, damage to a splice by virtue of flexural loads and/or tensile loads arising thereon can be avoided. A plane of main extent of the reinforcement extends in particular so as to be parallel with a longitudinal axis of the sheathing portion, at least in a non-wrapped and/or unwound state of the sheathing portion. The reinforcement preferably forms an inner layer of the sheathing portion, and/or a layer that is disposed between the upper side and the underside of the sheathing portion. The reinforcement advantageously comprises at least one woven fabric, in particular a plastics-material woven fabric, and/or is implemented as such a woven fabric. The reinforcement is in particular at least partially and advantageously at least largely implemented from polyester and/or polyamide. The reinforcement is preferably a polyester/polyamide woven fabric. The sheathing portion advantageously has at least a first surface layer, preferably from rubber, as has been mentioned above, at least a second surface layer, preferably from rubber, as has been mentioned above, and the reinforcement, wherein the reinforcement is particularly advantageously disposed between the first surface layer and the second surface layer. The sheathing portion particularly advantageously comprises at least a first adhesive layer which is disposed directly between and advantageously connects to one another the first surface layer and the reinforcement, and/or at least a second adhesive layer which is disposed directly between and advantageous connects to one another the reinforcement and the second surface layer. The first adhesive layer and/or the second adhesive layer are/is in particular embodied as an in particular liquid rubber adhesive layer, preferably having a thickness of at least 0.05 mm and particularly preferably of at least 0.1 mm, and/or of at most 5 mm and advantageously of at most 3 mm. A “plane of main extent” of an object is in particular to be understood to be a plane which is parallel with a largest lateral face of a smallest imaginary cuboid which is just large enough to still completely enclose the object and in particular runs through the center of the cuboid.

Damage to a splice, in particular by virtue of flexural loads arising thereon, can be avoided in particular when the sheathing portion has an elongation at break, in particular for an elongation of the sheathing portion along the longitudinal axis thereof, of at least 10%, advantageously of at least 15%, particularly advantageously of at least 25%, preferably of at least 35%, and particularly preferably of at least 40%.

A lower material input in terms of the sheathing material as well as in particular a lower degree in terms of production complexity can be achieved in particular when an overall length of regions having insertion ends is at most 100*N*d, wherein N is a number of longitudinal elements of the rope. The overall length of regions having insertion ends is advantageously at most 80*N*d, particularly advantageously at most 60*N*d, preferably at most 50*N*d, and particularly preferably at most 40*N*d. In particular, at least some of the regions having insertion ends are disposed, preferably along the longitudinal direction of the rope portion, so as to be, in particular directly, mutually adjacent. All regions having insertion ends can advantageously be disposed so as to be, in particular directly, mutually adjacent. In particular, the overall length of regions having insertion ends can correspond at least substantially to the length of the splice.

It is furthermore proposed that the splice has at least one, preferably precisely one, intermediate region which is disposed between insertion ends and which contains at least a portion of a core and/or of an in particular non-metallic replacement element. The replacement element herein functions in particular as a replacement for the core. The replacement element can be at least partially implemented from plastics material and/or from rubber, for example. A cross section of the replacement element preferably corresponds at least substantially to a cross section of the core. The intermediate region is advantageously disposed in a center of the splice. Particularly advantageously when viewed along the longitudinal direction of the rope portion, a first half of all insertion ends of the splice are disposed in front of the intermediate region, and a second half of all insertion ends of the splice are disposed behind the intermediate region. The intermediate region has in particular a length of at least 100*d and advantageously of at least 200*d. In the case of the splice being longer than 600*d, a length of the splice can advantageously be composed of the overall length of the regions having insertion ends and a length of the intermediate region. Said lengths can in particular add up to a length of the splice of 1200*d, in particular for reasons of adhering to predefined standards, wherein other and advantageously larger lengths are of course also conceivable. In the case of a target length of 1200*d for the splice, the intermediate region can have a length of 600*d and the region having the insertion ends can likewise have a length of 600*d, for example. The intermediate region can likewise be correspondingly lengthened and/or the region having insertion ends can be correspondingly shortened. A splice having a predefined length can be produced on account thereof, wherein a manufacturing complexity can advantageously be reduced by virtue of short insertion ends.

However, the splice is preferably free of any intermediate piece of this type such that the splice can advantageously be provided with a short overall length. It is proposed in particular that the splice has an overall length of at most 100*N*d. On account thereof, a production of a splice by virtue of the short length thereof can advantageously be simplified, in particular since a rope to be spliced has to be processed only on a comparatively short portion. The overall length of the splice corresponds in particular to a spacing between outermost insertion ends of the splice, preferably along the longitudinal direction of the latter. The splice at opposite end sides is preferably delimited by the core of the rope. Peripheral insertion ends of the splice are in particular contiguous to the core of the rope, wherein the overall length of the splice advantageously corresponds to a spacing between said peripheral insertion ends, in particular the ends thereof that face the core. The splice advantageously has an overall length of at most 80*N*d, particularly advantageously of at most 60*N*d, preferably of at most 50*N*d, and particularly preferably of at most 40*N*d. In particular in the case of a six-strand wire rope, for example, the splice has a length of at most 600*d, advantageously of at most 500*d, particularly advantageously of at most 400*d, preferably of at most 300*d, and particularly preferably of at most 250*d.

Advantageous properties in terms of a reliable splice which is in particular producible in a rapid manner and/or in a comparatively tight space can be achieved in particular with a rope, in particular an endless rope, which has at least one rope portion according to the invention. The rope is advantageously a wire rope. The rope is particularly advantageously a traction rope and/or a haul rope, in particular of a ropeway, advantageously of a passenger cableway, preferably of an urban cable car and/or a mountain cable car. The rope is in particular a person transporting wire rope, preferably an urban cable car wire rope and/or a mountain cable car wire rope. Of course, it is also conceivable that the rope is a traction rope and/or a haul rope of a ropeway for transporting materials, in particular a material transporting ropeway.

It is furthermore proposed to use at least one rope according to the invention, having at least one rope portion according to the invention, as a haul rope and/or as a traction rope, in particular in a passenger cableway, advantageously in a passenger ropeway, preferably in a mountain cable car and/or in an urban cable car. A use as a haul rope and/or as a traction rope in a ropeway for transporting materials, or any other type of ropeway, is however likewise conceivable.

The method moreover relates to a method for splicing a rope having a diameter d, in particular a wire rope, preferably a person transporting wire rope, preferably for producing an endless rope, in particular a rope according to the invention having at least one rope portion according to the invention, advantageously for a passenger cableway, for example for a mountain cable car and/or an urban cable car, wherein for producing at least one splice embodied as a long splice at least one insertion end is at least section-wise sheathed, in particular wrapped, with at least one sheathing portion of at least one sheathing element according to the invention. All of the insertion ends of the splice embodied as a long splice are preferably sheathed, in particular wrapped, with sheathing portions that are of mutually identical configuration and advantageously differ at most in terms of length. In particular, a plurality of sheathing portions can originate and/or be severed from the same sheathing element. Advantageous properties with a view to producing a splice, in particular a long splice, can be achieved on account of the method. Advantageously a complexity in the production of insertion ends of a splice, in particular of a long splice, can moreover advantageously be reduced. A splice, in particular a long splice, having short insertion ends that are simple to generate can moreover advantageously be provided. A high efficiency in terms of costs, in particular in combination with a simultaneously high reliability of a finished splice, in particular a long splice, can advantageously be achieved. In particular, a short time required for splicing can be achieved. Moreover, a compact splice capable of bearing loads, in particular a long splice, can be provided. Furthermore, splicing, in particular the long splice, can advantageously be enabled in a tight space and/or on a short length. In particular, a length of a region of a spliced connection to be processed in a complex manner can advantageously be reduced, in particular by means of the long splice.

The insertion end sheathed with the sheathing portion, in particular after the sheathing of said insertion end, is advantageously inserted between the other longitudinal elements over a length of at most 40*d, particularly advantageously of at most 30*d, preferably of at most 25*d, and particularly preferably of at most 20*d. Advantageously, a plurality of insertion ends, particularly advantageously all insertion ends of the splice, are inserted over a corresponding length of at most 50*d, in particular in each case in a sheathed state of said insertion ends.

A splice embodied as a long splice, the overall length thereof being at most 80*N*d, particularly advantageously at most 60*N*d, preferably at most 50*N*d, and particularly preferably at most 40*N*d, is advantageously produced. In particular in the case of a six-strand wire rope, for example, a splice, the overall length thereof being at most 600*d, advantageously at most 500*d, particularly advantageously at most 400*d, preferably at most 300*d, and particularly preferably at most 250*d, is produced.

In the method for splicing the rope by means of the long splice, the sheathing element is wound onto the insertion end in particular under a tensile force. The tensile force by way of which the sheathing element is wound onto the insertion end is in particular at least 1 kg, preferably at least 5 kg, advantageously at least 10 kg, particularly advantageously at least 15 kg, preferably at least 25 kg, and particularly preferably at most 50 kg.

It is furthermore proposed that the splice embodied as a long splice is fabricated in one piece, in particular without an advancement of the splice in an incomplete state, in a region having a length of at most 1200*d, advantageously of at most 1000*d, particularly advantageously of at most 800*d, and preferably of at most 600*d. An “advancement” is in particular to be understood, in this context, as a pushing and/or pulling of the splice in a partially complete state, in particular in a longitudinal direction of the rope. In particular, an advancement may be understood as a displacement of an already completed sub-portion of the incomplete splice out of a processing region, in particular conjointly with a displacement of a not yet completed further sub-portion of the incomplete splice into the processing region. The region can lie, for example, in a downhill station, an uphill station, a cable car station, or the like, in particular having a limited available space, for example having a limited length. The entire splice is in particular fabricated in one piece and/or within the region, without any advancement. A production complexity can be reduced on account thereof. Moreover, splicing in particular a splice that is embodied as a long splice can be enabled in a tight space, for example in tight stations, in particular cable car stations, for example in cities and/or on mountain slopes and/or peaks, where available space is limited.

A sheathing element according to the invention as well as a method according to the invention for splicing a rope herein are not to be limited to the application and the embodiment described above. A sheathing element according to the invention as well as a method according to the invention for meeting a functional mode described herein can in particular have a number of individual elements, components, units, and method steps that deviate from the number mentioned herein, and/or have any meaningful combination of said individual elements, components, units, and method steps. Moreover, where value ranges are stated in this disclosure, values lying within the stated limits are also intended to be disclosed and usable as desired.

### DRAWINGS

Further advantages are derived from the following description of the drawings. Exemplary embodiments of the invention are illustrated in the drawings. The drawings, the description, and the claims include numerous features in combination. A person skilled in the art will expediently also consider the features individually and combine them to form further meaningful combinations.

In the figures:

FIG. 1 shows a passenger cableway having a rope in a schematic illustration;

FIG. 2 shows the rope in a non-spliced state in a schematic illustration;

FIG. 3 shows the rope in a schematic cross-sectional illustration;

FIG. 4 shows a rope portion of the rope, having a splice, in a schematic illustration;

FIG. 5 shows a splice location of the splice in a schematic longitudinally sectioned illustration;

FIG. 6 shows an insertion end of the splice, having a sheathing portion, in a schematic plan view;

FIG. 7 shows part of the sheathing portion in a schematic sectional illustration;

FIG. 8 shows an upper side of the sheathing portion in a schematic plan view;

FIG. 9 shows a test rope piece of the rope in a test attempt, in a schematic illustration;

FIG. 10 shows a schematic flowchart of a method for splicing the rope; and

FIG. 11 shows an alternative sheathing element in a schematic perspective illustration.

### DESCRIPTION OF THE EXEMPLARY EMBODIMENTS

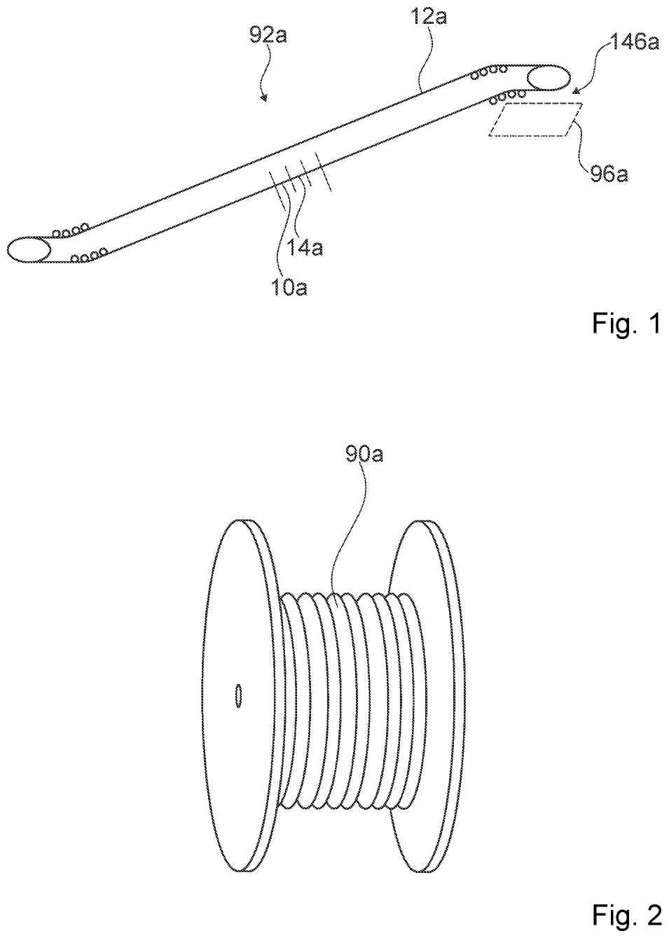

FIG. 1 shows a passenger cableway 92a having a rope 12a in a schematic illustration. The passenger cableway 92a is a ropeway. The passenger cableway 92a can be a mountain cable car, for example. The passenger cableway 92a is advantageously an urban cable car. It is conceivable herein that said passenger cableway covers a difference in altitude. It is likewise conceivable that the passenger cableway 92a runs at least in a substantially horizontal manner. The passenger cableway 92a can have support pylons (not shown). The passenger cableway 92a can moreover have a plurality of portions having dissimilar gradients, in particular also portions with a positive gradient as well as portions with a negative gradient. It is furthermore conceivable that the passenger cableway 92a at least section-wise runs underground. The rope 12a in the present case is a haul rope. The rope 12a is used as a haul rope in the passenger cableway 92a. The use as a traction rope, in particular in addition to a separate suspension rope, is likewise conceivable. In principle, it is furthermore conceivable that the rope 12a is part of a ropeway for transporting materials, in particular of a material mountain ropeway and/or a material urban ropeway. The rope 12a can in general be used as a traction rope and/or as a haul rope in a ropeway, and/or be part of said traction rope and/or haul rope.

The rope 12a in the present case is a wire rope, in particular a steel wire rope. However, the rope 12a, at least section-wise, can be embodied as a plastics material rope and/or a composite material rope, or the like. The rope 12a has at least one rope portion 10a having at least one splice 14a. The splice 14a in the present case is a long splice. The splice 14a in the present case is moreover a wire rope splice. The splice 14a, at least section-wise, is in particular embodied in the manner of a long splice. The rope 12a is an endless rope. The rope 12a is in particular an endless rope that is spliced by means of the splice 14a.

FIG. 2 shows a rope 90a which is configured to be spliced by means of the splice 14a of the rope portion 10a. The rope 90a corresponds in particular to the rope 12a of the passenger cableway 92a, in the non-spliced state of said rope 12a. The rope 12a, embodied as an endless rope, of the passenger cableway 92a can be produced by means of splicing the rope 90a. For example, the rope 90a, wound on a drum, is transported to an installation site, in particular a site of the passenger cableway 92a, and is spliced there. Fabrication of the rope 90a herein can take place at another site, for example in a rope factory.

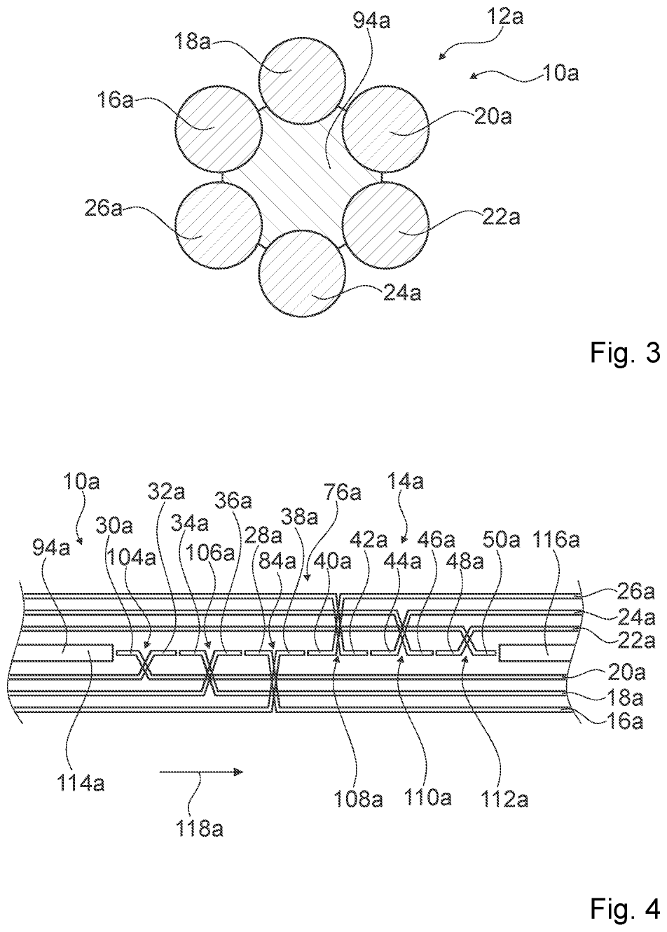

FIG. 3 shows the rope portion 10a in a schematic cross sectional illustration. In particular, a region of the rope portion 10a that is different from the splice 14a is shown in FIG. 3. A cross section of the rope 12a is implemented in a corresponding manner. The rope portion 10a, and in particular the rope 12a, has a number of N longitudinal elements 16a-26a. In the present case N=6. As mentioned above, any other number of longitudinal elements 16a-26a is however conceivable, in particular a number of five, seven, eight, ten, twelve, or even more. The longitudinal elements 16a-26a in the present case are strands, in particular wire strands. Wire bundles, or else individual wires, composite wires, core/shell longitudinal elements, or the like are likewise conceivable.

The longitudinal elements 16a-26a in the present case are implemented so as to be at least substantially mutually identical, or mutually identical. The longitudinal elements 16a-26a have in particular at least substantially identical, or identical, cross sections. Moreover, the longitudinal elements 16a-26a can have at least substantially identical, or identical, lay lengths and/or lay directions. The rope 12a can be a regular lay rope, and preferably is a lang lay rope. In principle, it is conceivable for the rope portion 10a and/or the rope 12a to have longitudinal elements 16a-26a of dissimilar configuration, which differ, for example, in terms of a cross section, a material, a tensile strength, a lay length, a lay direction, or the like.

The rope 12a, in the present case also at least one peripheral region of the rope portion 10a, has a core 94a. The core 94a can at least in part be implemented from plastics material, for example. The longitudinal elements 16a-26a are disposed about the core 94a, in particular at regular spacings. The longitudinal elements 16a-26a run in particular in a spiral manner about the core 94a. The longitudinal elements 16a-26a are stranded around the core 94a.

The core 94a in the present case has a cross section which is larger than a cross section of the longitudinal elements 16a-26a. Moreover, the core 94a advantageously has a cross section having segment-shaped clearances and/or impressions for the longitudinal elements 16a-26a, said clearances and/or impressions advantageously following a spiral profile around the core 94a, in accordance with a stranding of the longitudinal elements 16a-26a.

The longitudinal elements 16a-26a are advantageously disposed about the core 94a in such a manner that said longitudinal elements 16a-26a are without mutual contact at least outside the splice 14a. In particular, the longitudinal sides of the longitudinal elements 16a-26 are disposed without mutual contact, at least outside the splice 14a. Additionally, it is conceivable for longitudinal inserts to be disposed between the longitudinal elements 16a-26a, said longitudinal inserts in particular running about the core 94a so as to be parallel with said longitudinal elements 16a-26a and advantageously establishing a spacing between the longitudinal elements 16a-26a. Longitudinal inserts of this type are advantageously implemented from a material that is softer than that of the longitudinal elements 16a-26a, for example from plastics material, rubber, a composite material, or the like. Moreover, the rope 12a, or the rope portion 10a, respectively, and/or at least one, in particular a plurality, or else all, of the longitudinal elements 16a-26a can have at least one coating, for example an anti-corrosion coating and/or a plastics material covering, or the like.

The rope portion 10a and in particular the rope 12a have a diameter d. In particular, the diameter d corresponds to a diameter of a smallest circle surrounding the rope portion 10a, in particular the cross section thereof. The rope 12a in the present case is a round rope, in particular a circular rope. However, in principle it is also conceivable for the rope 12a to be polygonal or elliptic. In the present case, for example, the diameter d can be 70 mm, wherein arbitrary other diameters are conceivable, as mentioned above.

FIG. 4 shows the rope portion 10a of the rope 12a, having the splice 14a, in a schematic illustration. For reasons of visualization, the longitudinal elements 16a-26a in FIG. 4 are shown so as to be parallel and lying beside one another, despite said longitudinal elements 16a-26a potentially being stranded and/or running in a spiral manner about the core 94a, as has been mentioned. The illustration of the rope portion 10a and in particular of the splice 14a in FIG. 4 is therefore to be understood to be a splicing diagram and does not necessarily further reflect the actual geometry of the rope portion 10a and/or of the splice 14a thereof.

At least one of the longitudinal elements 16a has at least one insertion end 28a which is inserted at least section-wise between other longitudinal elements 16a-26a. The insertion end 28a is inserted between the longitudinal elements 16a-26a in place of the core 94a.

In the present case, all of the longitudinal elements 16a-26a have in each case two insertion ends 28a-50a. The insertion ends 28a-50a are inserted in the manner of a long splice, in place of the core 94a. The splice 14a comprises in particular twelve insertion ends 28a-50a, wherein another number of insertion ends are conceivable, in particular in the case of a rope having a number of longitudinal elements deviating from six.

The rope portion 10a in the peripheral regions thereof has the portions 114a, 116a of the core 94a. The portions 114a, 116a of the core 94a in the present case delimit the splice 14a.

The insertion end 28a has a length of at most 50*d. The insertion end 28a in the present case, for example, has a length of 40*d, wherein other lengths are also conceivable, as has been mentioned above.

Furthermore, the longitudinal elements 16a-26a have in each case at least one insertion end 28a-50a having a length of at most 50*d. Each of the longitudinal elements 16a-26a in the case shown has two insertion ends 28a-50a having a length of at most 50*d, for example having in each case a length of 40*d.

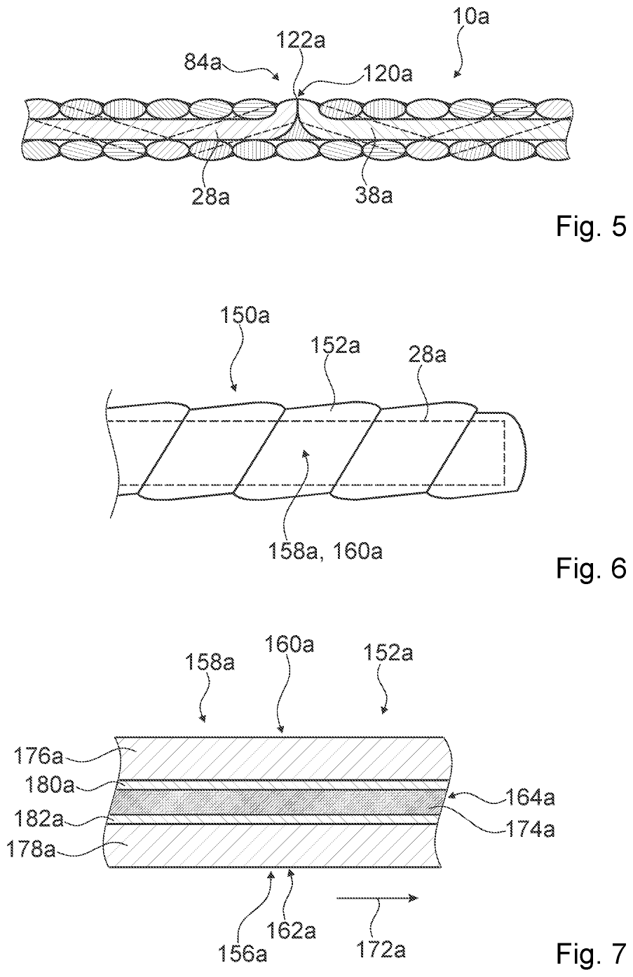

The splice 14a has at least one splice location 84a. FIG. 5 shows the splice location 84a of the splice 14a in a schematic longitudinally sectioned illustration. The splice location 84a herein is illustrated only in a schematic manner, wherein the length ratios in particular may not necessarily be correctly reproduced. The splice location 84a comprises a splice knot 120a. The splice location 84a furthermore comprises two insertion ends 28a, 38a that are inserted in opposite directions.

The insertion ends 28a, 38a in the present case extend in each case from a center 122a of the splice knot 120a up to the inserted ends of said insertion ends 28a, 38a, said inserted ends not being illustrated in FIG. 5. The insertion ends 28a, 38a herein can have in each case one inserted portion as well as one portion that is disposed on a surface of the splice 14a, wherein the latter configures in particular one part of the splice knot 120a. In the present case, those longitudinal elements 16a-26a that comprise the insertion ends 28a, 38a, in a region of the splice knot 120a in a known manner moreover run conjointly on the surface of the splice 14a. The longitudinal elements 16a-26a in the present case cross over one another. The splice knot 120a is in particular a reef knot.

Reference hereunder is made yet again to FIG. 4. The splice 14a has an overall length of at most 100*N*d. The splice 14a in the present case has an overall length of at most 600*d. The overall length of the splice 14a corresponds to a length of a portion between the portions 114a, 116a of the core 94a in the longitudinal direction 118a of the core portion 10a. In the present case, the overall length of the splice 14a is approximately 530*d, wherein other overall lengths are conceivable, as mentioned above.

Furthermore, an overall length of a region 76a having insertion ends 28a-50a is at most 100*N*d. In the present case, an overall length of the region 76a having insertion ends 28a-50a corresponds to the overall length of the splice 14a. The splice 14a is in particular free of regions, in particular having a length of at least 10*d, without insertion ends 28a-50a. However, it is likewise conceivable for the splice 14a to have at least one region without insertion ends 28a-50a, for example a central portion which advantageously comprises a portion of the core 94a and/or a replacement element for the core 94a.

The splice 14a has a plurality of splice locations 84a, 104a-112a, which are disposed at at least substantially regular spacings. In the present case, all of the splice locations 84a, 104a-112a of the splice 14a are disposed at regular spacings. Spacings between directly adjacent splice locations 84a, 104a-112a, are in each case at least substantially identical, or identical, in particular by virtue of identical lengths of the insertion ends 28a-50a.

FIG. 6 shows an insertion end 28a of the splice 14a, having a sheathing portion 152a of a sheathing element 150a in a schematic plan view. The insertion end 28a is sheathed with the sheathing portion 152a. In the present case, all of the insertion ends 28a-50a of the splice 14a of the rope portion 10a are sheathed with sheathing portions 152a of sheathing elements 150a of mutually identical configuration. Said sheathing portions 152a are not illustrated in FIGS. 4 and 5 for reasons of clarity, and accordingly are not provided with reference signs.

The sheathing portion 152a is suitable for permitting the splice 14a to be produced with a length of less than 100*N*d. Alternatively or additionally, the sheathing portion 152a is suitable for permitting the splice 14a to be produced with an overall length of regions having insertion ends 28a-50a that is less than 100*N*d. As mentioned above, regions of this type can be mutually separated by regions of the splice 14a without insertion ends 28a-50a. In the present case, the sheathing portion 152a is suitable for permitting the splice 14a to be produced with a length of less than 80*N*d, and advantageously with an even smaller length, as has been mentioned above. In particular, the splice 14a, the insertion ends 28a-50a thereof all being sheathed with sheathing portions 152a according to the invention, has a break strength, in particular a tensile strength, which is at most 20%, advantageously at most 10%, and particularly advantageously at most 5%, less than a break strength, in particular a tensile strength, of the rope 12a in a portion of the rope 12a that is different from the splice 14a, preferably in a portion without any splice 14a and/or insertion ends 28a-50a.

The sheathing element 150a in the present case is a tape, in particular a splicing tape. The sheathing portion 152a is at least one piece of the sheathing element 150a, in particular a severed and/or cut-off piece. However, the sheathing portion 152a can likewise comprise the entire sheathing element 150a. In the present case, the sheathing element 150a can originally be present as a rolled-up tape having a length of approximately 25 m, for example, wherein any other smaller or larger lengths are of course also conceivable. It is likewise conceivable for a plurality of, for example, two or three or four, sheathing elements 150a to be rolled so as to form a common roll.

The insertion end 28a is wrapped with the sheathing portion 152a. The sheathing portion 152a can be wrapped multiple times, and/or so as to at least partially overlap with itself, about the insertion end 28a. The insertion end 28a is advantageously wrapped with a single sheathing portion 152a. The sheathing portion 152a is particularly advantageously wrapped so as to be free on any overlaps with itself about the insertion end 28a. In particular, lateral edges of the sheathing portion 152a in a state wrapping the insertion end 28a abut one another. The sheathing portion 152a in the state wrapping the insertion end 28a advantageously configures an at least substantially planar surface about the insertion end 28a, said surface having in particular an at least substantially consistent diameter across the entire insertion end 28a. A wrapping with a plurality of sheathing portions 152a is likewise conceivable, in particular depending on a length of the insertion end 28a and/or a diameter of the insertion end 28a in comparison to a diameter of the core 94a. The insertion end 28a in the present case is sheathed with the sheathing portion 152a in such a manner that the cross section and/or diameter of said insertion end 28a is enlarged according to a cross section and/or diameter of the core 94a.

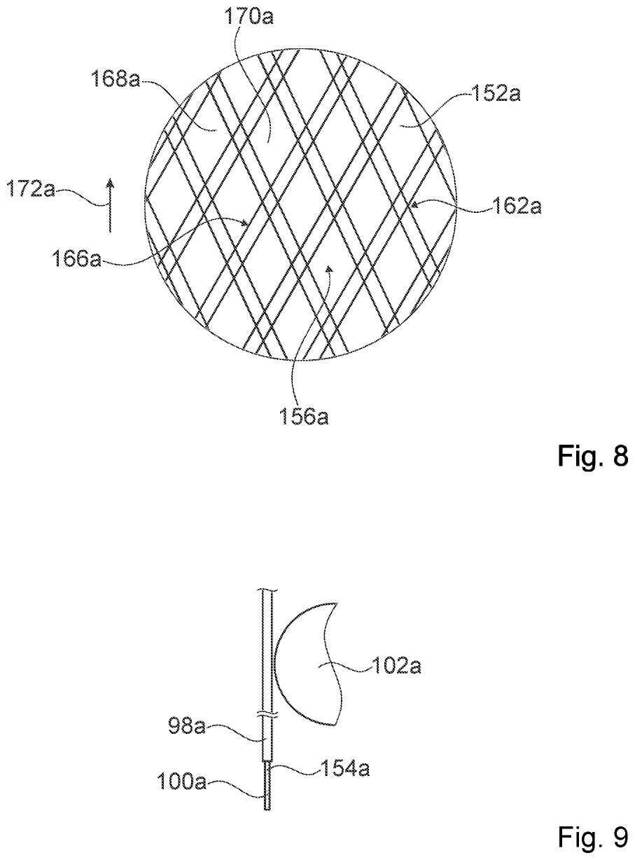

FIG. 7 shows part of the sheathing portion 152a in a schematic sectional illustration. FIG. 8 shows an upper side 160a of the sheathing portion 152a in a schematic plan view. The sheathing portion 152a in FIG. 7 is shown in an unrolled state and/or in a state not wrapped around the insertion end 28a.

The sheathing portion 152a in the present case has a width of approximately 20 mm, wherein any other widths are also conceivable, as mentioned above. Moreover, the sheathing portion 152a in the present case has a thickness of approximately 3 mm, wherein this value is likewise to be understood to be exemplary.

The sheathing portion 152a has at least a first region 156a and at least a second region 158a which differ in terms of at least one material parameter. In particular the sheathing portion 152a in the first region 156a is realized differently than in the second region 158a.

In the present case, the first region 156a comprises an underside 162a of the sheathing portion 152a, and the second region 158a comprises the upper side 160a of the sheathing portion 152a. The upper side 160a and the underside 162a of the sheathing portion 152a differ in particular in terms of the material parameter.

The first region 156a and the second region 158a differ in terms of a surface structure of the sheathing portion 152a. In the present case, the sheathing portion 152a in the first region 156a has a greater roughness than in the second region 158a. A surface of the sheathing portion 152a in the second region 158a is advantageously smooth, in particular smooth fabric, advantageously sanded. Moreover, a surface of the sheathing portion 152a in the first region 156a is advantageously rough and/or structured. In the present case, the upper side 160a of the sheathing portion 152a is smooth. Moreover, in the present case the underside 162a of the sheathing portion 152a is structured.

In the present case, the sheathing portion 152a in the first region 156a has a surface structure 166a. The surface structure 166a in the present case comprises a plurality of structural elements 168a, 170a, not all of the latter being provided with reference signs for reasons of clarity. The structural elements 168a, 170a in the present case are implemented as elevations. Alternatively or additionally, depressions are conceivable. The surface structure 166a in the present case forms a regular pattern, in particular a diamond pattern. The surface structure 166a comprises in particular a diamond profile. The structural elements 168a, 170a are advantageously diamond-shaped, wherein any other cross sections are conceivable, as mentioned above. The structural elements 168a, 170a advantageously have a cross section of at least 3 mm², particularly advantageously of at least 5 mm² and preferably of at least 10 mm², wherein larger or smaller cross sections are also conceivable.

Furthermore, the sheathing portion 152a in the present case in the first region 156a has a lower Shore A hardness than in the second region 158a. For example, the sheathing portion 152a in the first region 156a can have a Shore A hardness of 75, and/or in the second region 158a can have a Shore A hardness of approximately 85.

It is furthermore conceivable for the first region 156a and the second region 158a to differ in terms of further material parameters such as, for example, a material and/or a material thickness and/or generally a geometry or the like.

The sheathing portion 152a has at least one reinforcement 164a. The reinforcement 164a in the present case is a reinforcement tier. The reinforcement 164a comprises at least one woven fabric 174a, in particular a polyester/polyamide woven fabric, wherein other materials are also conceivable, as mentioned above. The reinforcement 164a is implemented so as to be planar.

The sheathing portion 152a is realized in multiple layers. The sheathing portion 152a in the present case comprises a first surface layer 176a. The first surface layer 176a configures the upper side 160a of the sheathing portion 152a. The sheathing portion 152a furthermore comprises a second surface layer 178a. The second surface layer 178a configures the underside 162a of the sheathing portion 152a. The first surface layer 176a and/or the second surface layer 178a in the present case are/is implemented at least in part or preferably in full from plastics material, in particular from rubber, advantageously from polychloroprene rubber.

The sheathing portion 152a furthermore comprises a first adhesive layer 180a. The first adhesive layer 180a connects the first surface layer 176a to the reinforcement 164a. The first adhesive layer 180a is disposed directly between the first surface layer 176a and the reinforcement 164a. The sheathing portion 152a moreover comprises a second adhesive layer 182a. The second adhesive layer 182a connects the second surface layer 178a to the reinforcement 164a. The second adhesive layer 182a is disposed directly between the reinforcement 164a and the second surface layer 178a. The first adhesive layer 180a and/or the second adhesive layer 182a are/is advantageously embodied as an in particular liquid rubber adhesive layer. The first adhesive layer 180a and/or the second adhesive layer 182a preferably have/has a thickness between 0.1 mm and 0.3 mm.

The sheathing portion 152a has a tear strength of at least 15 N/mm², in particular in parallel with a longitudinal direction 172a of the sheathing portion 152a. The sheathing portion 152a in the present case advantageously has a tear strength of at least 25 N/mm².

The sheathing portion 152a furthermore has an elongation at break of at least 10%, in particular in the case of an elongation in the longitudinal direction 172a of the sheathing portion 152a. The sheathing portion 152a in the present case advantageously has an elongation at break of at least 15% and particularly advantageously of at least 25%.

FIG. 9 shows a test rope piece 98a of the rope 12a in a test attempt, in a schematic illustration. The test rope piece 98a section-wise has a construction identical to that of the rope 12a, in particular in a region which is different from the rope portion 10a and is advantageously not spliced. The test rope piece 98a moreover has at least one test insertion end 100a. The test rope piece 98a in the present case has precisely one test insertion end 100a. The test insertion end 100a is inserted at one end of the test rope piece 98a between the longitudinal elements thereof (not individually illustrated), in place of a core (not shown) of the test rope piece 98a. The test rope piece 98a has in particular a number of N longitudinal elements of this type.

The test insertion end 100a is advantageously realized so as to be identical to insertion ends 28a-50a of the splice 14a. The test insertion end 100a is in particular sheathed with a test piece 154a of the sheathing portion 152a, in particular in a manner analogous to the insertion end 28a. The test piece 154a of the sheathing portion 152a is advantageously realized so as to be identical to the sheathing portion 152a, and advantageously differs therefrom at most in terms of length. However, the test insertion end 100a can be inserted thereinto from one end of the test rope piece 98a, and not laterally at a splice location. In principle however, it is also conceivable for the test rope piece 98a to comprise at least one portion of a test splice, or an entire test splice.

The test insertion end 100a in the test attempt is under a tensile load. Moreover, the test attempt is carried out while the test rope piece 98a is under a tensile load. The test insertion end 100a in the test attempt is capable of being bent without damage at least 1000 times about a test disk 102a having a diameter of at most 80*d.

In the present case, the test insertion end 100a is capable of being bent, for example, at least 2000 times about in each case at least 90° and advantageously about in each case at least 150°. Moreover, the diameter of the test disk 102a can advantageously be at most 60*d, or at most 40*d. A revolving of the splice 14a about a drive pulley of a ropeway can be simulated by means of the test attempt, for example. The insertion ends 28a-50a of the splice 14a are realized in such a manner that an identically implemented test insertion end 100a survives the described test attempt without damage.

The test rope piece 98a in the test attempt is pretensioned by way of a pretensioning force of at least 60 N/mm² per cross-sectional area A. The test rope piece 98a in the test attempt is advantageously pretensioned by way of a pretensioning force of at least 500 N/mm² per cross-sectional area.

The test insertion end 100a sheathed with the test piece 154a of the sheathing portion 152a in the test attempt withstands an extraction force in kN of at least d²*0.68/N*0.1. The test insertion end 100a advantageously withstands an extraction force of at least d²*0.68/N*0.2, and particularly advantageously of at least d²*0.68/N*0.4. In the present case, each of the insertion ends 28a-50a of the splice 14a withstands a correspondingly high extraction force.

A test piece 154a of the sheathing portion 152a which sheathes the test insertion end 100a by the length of at most 50*d, said test piece 154a being inserted into the test rope piece 98a, withstands a shear modulus of at least 1 MPa. The test piece 154a of the sheathing portion 152a which sheathes the test insertion end 100a advantageously withstands a shear modulus of at least 30 MPa. In the present case, each of the sheathing portions 152a, which wraps insertion ends 28a-50a of the splice 14a embodied as a long splice, withstands a correspondingly high shear modulus.

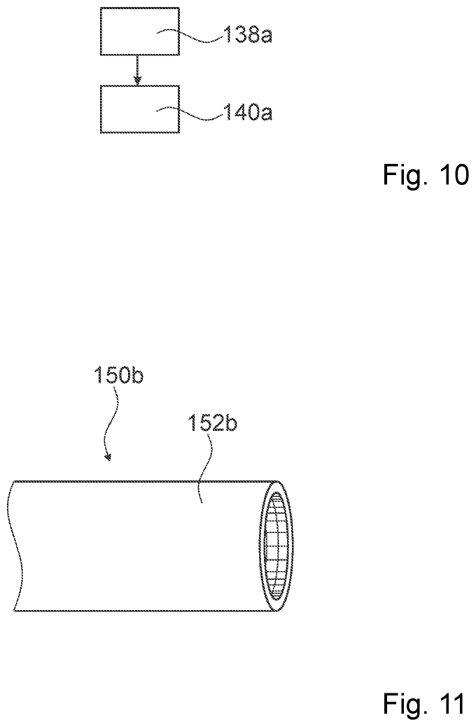

FIG. 10 shows a schematic flow diagram of a method for splicing the rope 90a (cf. FIG. 2), wherein in particular the rope 12a of the passenger cableway 92a (cf. FIG. 1) is fabricated. In a first method step 138a, the rope 90a having a diameter d, in particular a nominal diameter d, having a plurality of stranded longitudinal elements 16a-26a is provided, for example at a site of the passenger cableway 92a. In a second method step 140a, the splice 14a is fabricated by means of splicing the rope 90a. In order for the splice 14a to be produced, at least one insertion end 28a-50a is at least section-wise sheathed with the sheathing portion 152a of the sheathing element 150a. In particular, the at least one insertion end 28a-50a is wrapped with the sheathing portion 152a, advantageously in such a manner that the diameter and/or the cross section of said insertion end 28a-50a corresponds at least substantially to a diameter and/or cross section of the core 94a. In the present case, all of the insertion ends 28a-50a are sheathed with corresponding sheathing portions 152a. A plurality of sheathing portions 152a per insertion end 28a-50a can be used herein, depending on the length of the insertion ends 28a-50a, or of the sheathing portions 152a. Alternatively, a single sheathing portion 152a can be used.

In order for the splice 14a to be produced in the present case, at least one end region of at least one of the longitudinal elements 16a-26a in a sheathed state is inserted as an insertion end 28a-50a over a length of at most 50*d, for example over a length of 40*d, between other longitudinal elements 16a-26a. In the present case, all of the insertion ends 28a-50a are inserted over a length of in each case at most 50*d, for example over a length of in each case 40*d.

In the second method step 140a, the splice 14a is advantageously fabricated in one piece in a region 96a having a length of at most 1200*d (cf. also FIG. 1). The splice 14a is in particular fabricated without said splice 14a being advanced in an incomplete state. The region 96a in the present case has a length of at most 900*d and advantageously of at most 700*d. In particular, the region 96a can have, in particular only, a maximum space available for splicing, for example in the case of a limited space in a cable car station 146a of the passenger cableway 92a.

A further exemplary embodiment of the invention is shown in FIG. 11. The description hereunder is limited substantially to the points of differentiation between the exemplary embodiments, wherein reference in terms of unmodified components, features, and functions, may be made to the description of the exemplary embodiment of FIGS. 1 to 10. In order for the exemplary embodiments to be differentiated, the suffix a in the reference signs of the exemplary embodiment in FIGS. 1 to 10 has been replaced by the suffix b in the reference signs of the exemplary embodiment of FIG. 11. In terms of unmodified components, in particular of components having identical reference signs, reference in principle may be made to the drawing and/or the description of the exemplary embodiment of FIGS. 1 to 10.

FIG. 11 shows an alternative sheathing portion 152b of an alternative sheathing element 150b in a schematic perspective illustration. The alternative sheathing portion 152b is implemented in the manner of a hose. The alternative sheathing portion 152b is configured to be pulled over an insertion end (not shown) of a splice (not shown). When producing the splice, the insertion end can be sheathed in particular in that the alternative sheathing portion 152b is pulled over rather than wrapped.

Furthermore, the alternative sheathing portion 152b in the present case is configured to be shrink-fitted onto an insertion end. The alternative sheathing portion 152b is in particular configured to be pulled over in a non-shrunk state, and for subsequently being shrink-fitted. The alternative sheathing portion 152b herein at least section-wise advantageously realizes a form-fitting connection to the insertion end, in particular to the outer longitudinal elements of the latter.

It is likewise conceivable that a sheathing element is extruded onto an insertion end. A form-fitting connection can likewise be achieved herein. Multi-component extruding is to be considered in particular to this end, wherein a rubber layer and a reinforcement layer are simultaneously extruded, for example.

1. A sheathing element, in particular a splicing tape, having at least one sheathing portion which is configured for an at least section-wise sheathing of at least one insertion end of at least one splice, embodied as a long splice, for a rope, in particular for a wire rope, advantageously for a haul rope and/or a traction rope, having a diameter d and a number of N stranded longitudinal elements, in particular strands, wherein the sheathing portion is suitable for permitting the splice to be produced with a length of less than 100*N*d.

2. The sheathing element as claimed in claim 1, wherein a test insertion end of a length of at most 50*d, which is inserted in a test rope piece with N stranded longitudinal elements and is sheathed with a test piece of the sheathing portion stranded, withstands an extraction force in kN of at least d²*0.68/N*0.04 and advantageously of at least d²*0.68/N*0.1.

3. The sheathing element as claimed in claim 1, wherein a test piece of the sheathing portion which sheathes a test insertion end of the length of at most 50*d, which is inserted in a test rope piece with N stranded longitudinal elements, withstands a shear modulus of at least 1 MPa, advantageously of at least 5 MPa, and preferably of at least 30 MPa.

4. The sheathing element as claimed in claim 1, wherein the sheathing portion has at least one first region and at least one second region which differ in terms of at least one material parameter.

5. The sheathing element as claimed in claim 4, wherein the first region and the second region differ in terms of a surface structure of the sheathing portion.

6. The sheathing element as claimed in claim 5, wherein the first region comprises an underside of the sheathing portion, and the second region comprises an upper side of the sheathing portion.

7. The sheathing element as claimed in claim 1, wherein the sheathing portion has a tear strength of at least 15 N/mm², advantageously of at least 20 N/mm², and particularly advantageously of at least 25 N/mm².

8. The sheathing element as claimed in claim 1, wherein the sheathing portion has at least one reinforcement.

9. The sheathing element as claimed in claim 1, wherein the sheathing portion has an elongation at break of at least 10%, and advantageously of at least 15%.

10. A rope portion of a rope, in particular of an endless rope, preferably of a wire rope, in particular of a person transporting wire rope, having at least one splice that is embodied as a long splice, in particular a wire rope splice, which has a plurality of stranded longitudinal elements, in particular strands, at least one of which has at least one insertion end which is inserted between other longitudinal elements at least section-wise, in particular in place of a core, and which is sheathed at least section-wise with at least one sheathing portion of at least one sheathing element as claimed in claim 1.

11. The rope portion as claimed in claim 10, wherein the insertion end has a length of at most 50*d, wherein d is a diameter of the rope.

12. The rope portion as claimed in claim 10, wherein the splice that is embodied as a long splice has an overall length of at most 100*N*d, wherein N is a number of longitudinal elements of the rope, and d is a diameter of the rope.

13. A rope, in particular an endless rope, preferably a wire rope, in particular a person transporting wire rope, having at least one rope portion as claimed in claim 10.

14. A use of a rope as claimed in claim 13 as a haul rope and/or as a traction rope, in particular in a passenger cableway, advantageously in a mountain cable car and/or in an urban cable car.

15. A method for splicing a rope having a diameter d, in particular a wire rope, preferably a person transporting wire rope, preferably for producing an endless rope, in particular a rope as claimed in claim 14, advantageously for a passenger cableway, for example for a mountain cable car and/or an urban cable car wherein, for producing at least one splice embodied as a long splice, at least one insertion end is sheathed at least section-wise with at least one sheathing portion of at least one sheathing element, in particular a splicing tape, having at least one sheathing portion which is configured for an at least section-wise sheathing of at least one insertion end of at least one splice, embodied as a long splice, for a rope, in particular for a wire rope, advantageously for a haul rope and/or a traction rope, having a diameter d and a number of N stranded longitudinal elements, in particular strands, wherein the sheathing portion is suitable for permitting the splice to be produced with a length of less than 100*N*d.

16. The method as claimed in claim 15, wherein the splice that is embodied as a long splice is fabricated in one piece, in particular without an advancement of the splice in an incomplete state, in a region having a length of at most 1200*d.
